(19) United States
(12) Patent Application Publication
(10) Pub. No.: US 2022/0221154 A1
(43) Pub. Date: Jul. 14, 2022

(54) Light Cooking Device and Light Cooking Method

(71) Applicant: Yoshihisa Usami, Shizuoka (JP)

(72) Inventor: Yoshihisa Usami, Shizuoka (JP)

(21) Appl. No.: 17/529,424

(22) Filed: Nov. 18, 2021

(30) Foreign Application Priority Data
Jan. 14, 2021 (JP) 2021-004128

(51) Int. Cl. F24C 7/04; H05B 6/64; H05B 11/00; H05B 1/02

(52) U.S. Cl. CPC F24C 7/04; H05B 1/0263; H05B 11/00; H05B 6/6432

(57) ABSTRACT

Provided is a light cooking device, including: a light source; and a light condensing unit configured to transmit light from the light source through the light condensing unit and condense the light to at least a part of a cooking material. The light source is at least one selected from LEDs, OLEDs, and lasers.

### BACKGROUND OF THE INVENTION

### Field of the Invention

The present disclosure relates to a light cooking device and a light cooking method.

### Description of the Related Art

Hitherto, ovens and microwave ovens have been widely used as cooking devices for heating and cooking foods using light such as infrared rays and microwaves.

Ovens use infrared rays, which are absorbed into all kinds of substances. Therefore, ovens can heat cooking materials from the surface of the cooking materials.

In recent years, food broilers have been proposed with a view to browning the surface of cooking materials in a desired manner. A proposed food broiler includes: an infrared heater configured to output infrared rays; and an integrating tube having an opening in the outer circumference thereof counter to a cooking material, and is configured to irradiate the surface of a food with infrared rays to form a browned surface (for example, see Japanese Patent Application Laid-Open (JP-A) No. 2015-43984). Moreover, surface-burning food producing devices have been proposed with a view to heating and burning only a predetermined range of the surface of a cooking material. A proposed surface-burning food producing device includes a plurality of a pinpoint-condensing near-infrared heaters each including a lamp unit housed in a mirror member (for example, see Japanese Patent (JP-B) No. 6691270).

On the other hand, microwave ovens use microwaves that can vibrate and heat water molecules. Therefore, microwave ovens can heat cooking materials from inside the cooking materials.

### SUMMARY OF THE INVENTION

According to an embodiment of the present disclosure, a light cooking device includes:

a light source; and

a light condensing unit configured to transmit light from the light source through the light condensing unit and condense the light to at least a part of a cooking material,

wherein the light source is at least one selected from LEDs. OLEDs, and lasers.

### BRIEF DESCRIPTION OF THE DRAWINGS

FIG. 1A is a schematic front cross-sectional view of a light cooking device of the present disclosure in an embodiment;

FIG. 1B is an expanded view of a light source and a light condensing unit of a light cooking device of the present disclosure in an embodiment;

FIG. 1C is a schematic side cross-sectional view of a light cooking device of the present disclosure in an embodiment;

FIG. 2 is a schematic front cross-sectional view of a light cooking device of the present disclosure in another embodiment;

FIG. 3 is a schematic front cross-sectional view of a light cooking device of the present disclosure in another embodiment;

FIG. 4 is a schematic front cross-sectional view of a light cooking device of the present disclosure in another embodiment;

FIG. 5 is a schematic perspective view of a light cooking device of the present disclosure in another embodiment; and

FIG. 6 is a schematic front cross-sectional view of an existing cooking device.

### DETAILED DESCRIPTION OF THE INVENTION

### [Light Cooking Device and Light Cooking Method]

A light cooking device of the present disclosure includes a light source and a light condensing unit, and further includes other units as needed.

Examples of the other units include a light leakage preventing unit, a placing unit, a protecting unit, a microwave shielding unit, a cooling unit, and a sensing unit.

A light cooking method of the present disclosure can be performed using the light cooking device.

The present disclosure has an object to provide a cooking device that can heat a whole of a cooking material uniformly without unevenness and can form a browned surface over all surfaces of the cooking material.

The present disclosure can provide a cooking device that can heat a whole of a cooking material uniformly without unevenness and can form a browned surface over all surfaces of the cooking material.

The cooking devices of JP-A No. 2015-43984 and JP-B No. 6691270 have a problem that they cannot heat the whole of a cooking material uniformly but tend to heat and cook the cooking material unevenly because the internal temperature of the cooking material is lower than the surface temperature of the cooking material. Moreover, a browned surface can be formed only over the front surface or the back surface of a cooking material, and cannot be formed over all surfaces of the cooking material.

Microwave ovens use microwaves that can vibrate and heat water molecules. Therefore, microwave ovens can heat a cooking material from inside the cooking material, but have a problem that they cannot form a browned surface that serves as an accent to the dish.

The present inventors have completed the present disclosure as a result of conducting earnest studies in order to obtain a cooking device that can solve the problems described above, and can heat the whole of a cooking material uniformly and form a browned surface over all surfaces of the cooking material.

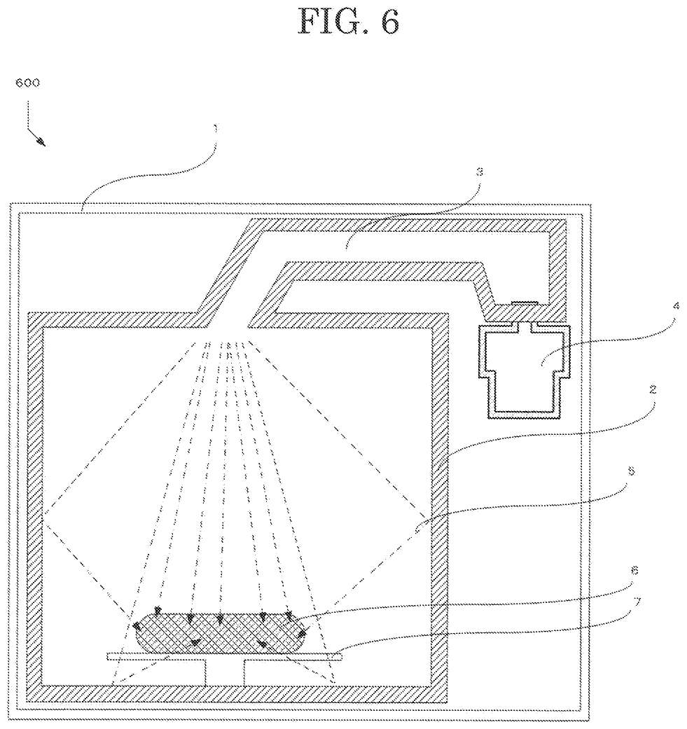

An existing cooking device will be described with reference to FIG. 6.

FIG. 6 is a schematic front cross-sectional view of an existing cooking device. The cooking device 600 includes a housing 1, a cooking chamber 2, a waveguide 3, a microwave generator 4, and a cooking table 7. A cooking material 6 is placed on the cooking table 7. Microwaves generated by the microwave generator 4 are repeatedly reflected on the wall surfaces inside the cooking chamber 2, and the cooking material 6 is irradiated with the microwaves from all directions within 360 degrees. The microwaves irradiating the cooking material 6 permeate the inside of the cooking material 6 and heat the cooking material 6 from the inside. In this way, the microwaves can warm the whole of the cooking material 6. However, the heating unit using the microwaves has a problem that it cannot form a browned surface that serves as an accent to the dish.

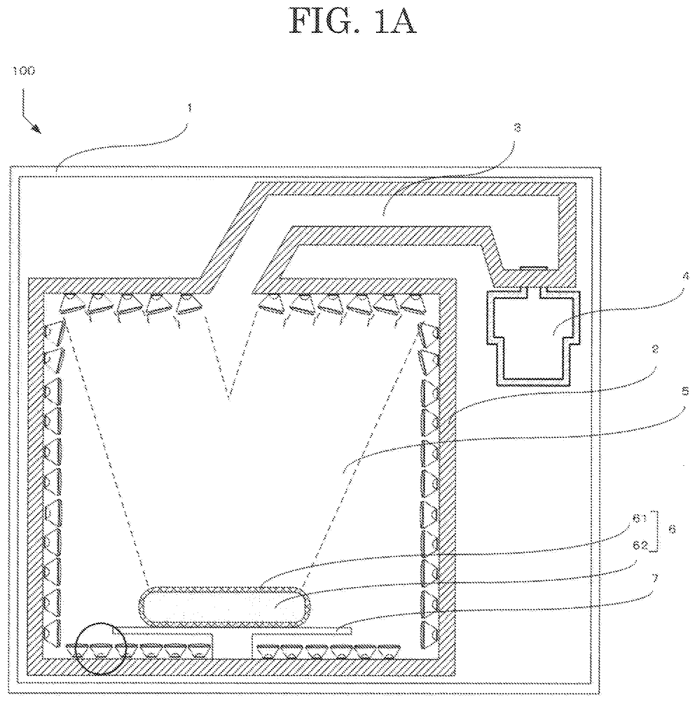

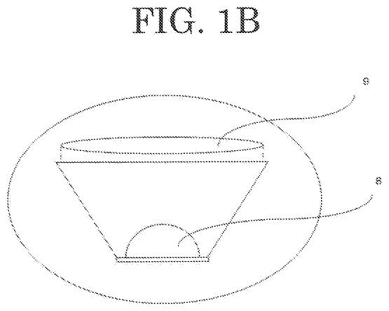

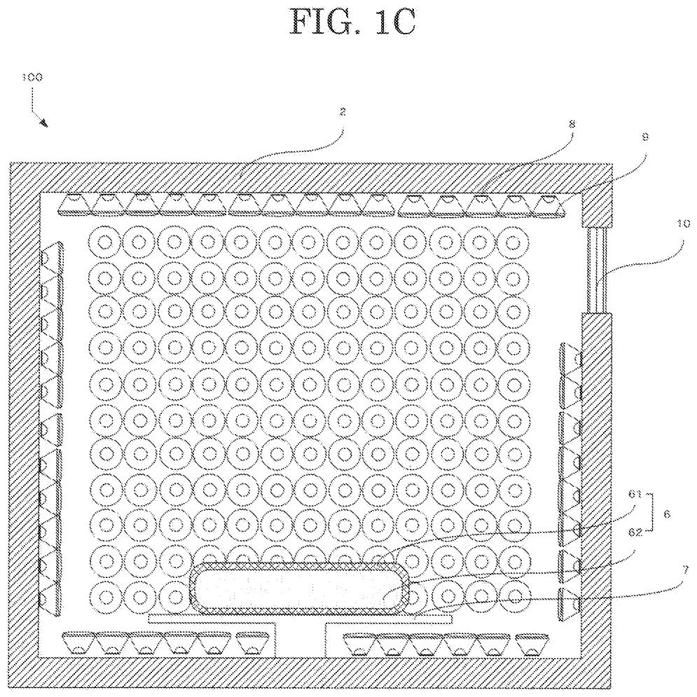

Embodiments of the light cooking device of the present disclosure will be described with reference to FIG. 1A, FIG. 1B, and FIG. 1C. However, applications of the cooking device of the present disclosure are not limited to these embodiments.

The same components are denoted by the same reference numerals in the drawings, and any matters these components have in common may not be described redundantly. For example, the number, position, and shape of the components are not limited to these embodiments, and may be any number, position, and shape that are suitable for carrying out the present disclosure.

FIG. 1A is a schematic front cross-sectional view of the light cooking device of the present disclosure in an embodiment. FIG. 1B is an expanded view of a light source and a light condensing unit (a region enclosed within a solid line illustrated in the lower left portion of FIG. 1A) of the light cooking device illustrated in FIG. 1A in an embodiment. FIG. 1C is a schematic left-side cross-sectional view of the light cooking device illustrated in FIG. 1A in an embodiment.

The light cooking device 100 includes a housing 1 and a cooking chamber 2 serving as a light leakage preventing unit, a waveguide 3, a microwave generator 4, a cooking table 7 serving as a placing unit, LEDs 8 serving as light sources, lenses 9 serving as light condensing units, and a peep window 10. A plurality of LEDs 8 and a plurality of lenses 9 are disposed on all wall surfaces inside the cooking chamber 2. A cooking material 6 is placed on the cooking table 7. FIG. 1A does not illustrate light paths other than light paths 5 from the light sources on the top surface, and the LEDs 8 and the lenses 9 disposed on the rear surface of the cooking chamber. FIG. 1C does not illustrate the housing 1, the waveguide 3, the microwave generator 4, and light paths 5.

Rays of light emitted from the LEDs 8 are condensed through the lenses 9, and come incident into the cooking material 6 from all directions within 360 degrees as indicated by the light paths 5. In this way, all surfaces of the cooking material 6 can be heated uniformly. When the irradiation time is short, rays of light emitted from the LEDs 8 are absorbed by the surface of the cooking material 6. Therefore, a heated portion 61 and an unheated portion 62 are formed in the cooking material 6. When the irradiation time is increased, the unheated portion 62 of the cooking material 6 is heated through heat transfer.

### <Heating Unit by Microwaves>

It is preferable that the light cooking device of the present disclosure use a heating unit by microwaves in combination. Using a heating unit by microwave in combination, the light cooking device can heat not only the heated portion 61 of the cooking material, but also the unheated portion 62 in a short time efficiently. That is, the light cooking device can heat the whole of the cooking material 6 uniformly, and can form a browned surface over all surfaces of the cooking material 6.

### <Light Sources>

As the light sources, OLEDs and lasers may also be used in addition to the LEDs 8. Among these light sources, light emitting diodes (LEDs) and organic light emitting diodes (OLEDs) are preferable because they have a high light emitting efficiency and short switching times (i.e., a short rising time and a short falling time), and can irradiate a wide range.

One kind of the light sources may be provided alone or two or more kinds of the light sources may be provided in combination.

The material, shape, size, and structure of the light sources are not particularly limited and may be appropriately selected depending on the intended purpose.

It is preferable that the light cooking device of the present disclosure include a plurality of light sources because this makes it possible to irradiate a wide range and in terms of producing a resultant wave from rays of light and improve the heating efficiency.

When LEDs are used as the light sources, the wavelength of light from the light sources is not particularly limited, may be appropriately selected depending on the intended purpose, and is preferably 200 nm or longer but 2,000 nm or shorter, more preferably 300 nm or longer but 1,500 nm or shorter, yet more preferably 350 nm or longer but 1,000 nm or shorter, and particularly preferably 400 nm or longer but 800 nm or shorter because the light emitting efficiency and the transmittance into foods are good.

It is preferable that the light sources have a peak at 1,000 nm or less in terms of a high light emitting efficiency. This is preferable because the cooking material can be cooked efficiently.

When it is desired to heat the inside of the cooking material, it is preferable to use a wavelength in the visible light range (for example, 400 nm or longer but 800 nm or shorter) in which the light has a high transmittance.

When it is desired to heat the surface of the cooking material, it is preferable to use a wavelength in an infrared light range (for example, 2,000 nm or longer) in which the light has a low transmittance.

By combining a wavelength in the visible light range and a wavelength in the infrared light range, it is possible to perform both of heating the inside and heating the surface.

It is preferable that the rays of light from the plurality of light sources have different wavelengths from each other. This makes it possible to vary the wavelength depending on the light absorption efficiency of the cooking material and heat and cook the cooking material more efficiently. It is possible to vary the wavelength by using a wavelength-variable light source or using a plurality of light sources having different wavelengths.

### <Microwave Shielding Unit>

When the light cooking device of the present disclosure uses the heating unit by microwaves in combination, it is preferable to provide a microwave shielding unit (unillustrated) that covers the light sources in order to prevent damage or deterioration of the light sources.

The material of the microwave shielding unit is not particularly limited and may be appropriately selected depending on the intended purpose so long as the material can shield microwaves and has translucency. Examples of the material of the microwave shielding unit include metal oxides.

The structure of the microwave shielding unit is not particularly limited and may be appropriately selected depending on the intended purpose so long as the structure can shield microwaves and has transparency. Examples of the structure of the microwave shielding unit include a structure having a plurality of pores, and a structure including a window covered with a transparent conductive film.

The shape and size of the microwave shielding unit are not particularly limited and may be appropriately selected depending on the intended purpose.

When a metal oxide is used as the microwave shielding unit, the dimension of the pores in the metal oxide is not particularly limited and may be appropriately selected depending on the intended purpose so long as the dimension is less than or equal to the wavelength of the microwaves and can allow light to be transmitted through the pores. The upper limit of the dimension of the pores in the metal oxide is preferably 100 mm or less, more preferably 50 mm or less, yet more preferably 10 mm or less, and particularly preferably 5 mm or less. The lower limit of the dimension of the pores in the metal oxide is preferably 0.01 mm or greater, more preferably 0.1 mm or greater, yet more preferably 0.5 mm or greater, and particularly preferably 1 mm or greater.

The constituent material, shape, size, and structure of the metal oxide are not particularly limited and may be appropriately selected depending on the intended purpose.

The material of the transparent conductive film is not particularly limited and may be appropriately selected depending on the intended purpose so long as the material is one that is used for, for example, electrode conductive films of liquid crystals and electrodes of transparent touch panels. Examples of the material of the transparent conductive film include oxides such as ITO, ATO, FTO, AZO, and GZO, and Ag and Cu thin wires.

The shape, size, and structure of the transparent conductive film are not particularly limited and may be appropriately selected depending on the intended purpose.

The irradiation angles of the light sources are not particularly limited and may be appropriately selected depending on the intended purpose, and are preferably angles at which rays of light from the plurality of light sources would travel in different directions from each other. This makes it possible to produce a resultant wave from light emitted from one of the light sources and light emitted from another one of the light sources as illustrated in FIG. 1A, and improve the heating efficiency of the cooking material.

By designing the light sources in a movable manner, it is easy to adjust the irradiation angles.

### <Light Condensing Units>

When the light sources are LEDs, the light condensing units are preferably collimator lenses because collimator lenses can condense rays of light in a wide angular range.

The material of the light condensing units is not particularly limited and may be appropriately selected depending on the intended purpose. Examples of the material of the light condensing units include glass, acrylics, polycarbonates, olefins, styrenes, silicon resins, and plastics. Among these materials, glass, polycarbonates, polyolefins, silicon resins, and plastics are preferable in terms of heat resistance.

Examples of the plastics include silicon resins, PI (polyimide), PEEK (polyether ether ketone), PPS (polyphenylene sulfide), PEI (polyether imide), PPSU (polyphenyl sulfone), PVDF (polyvinylidene fluoride), PA (polyacrylate), PC (polycarbonate), PET (polyethylene terephthalate), PBT (polybutylene terephthalate), POM (polyoxymethylene), UHMWPE (ultrahigh-molecular-weight polyethylene), PP (polypropylene), PE (polyethylene), PPE (polyphenyl ether), and ABS (poly(acrylonitrile butadiene styrene)). Among these plastics, silicon resins, PI, PET, and PC are preferable in terms of heat resistance.

The shape, size and structure of the light condensing units are not particularly limited and may be appropriately selected depending on the intended purpose.

### <Placing Unit>

The material of the placing unit is not particularly limited and may be appropriately selected depending on the intended purpose so long as the material has translucency and heat resistance. Examples of the material of the placing unit include plastics.

Examples of the plastics include silicon resins, PI (polyimide), PEEK (polyether ether ketone), PPS (polyphenylene sulfide), PEI (polyether imide), PPSU (polyphenyl sulfone). PVDF (polyvinylidene fluoride), PA (polyacrylate), PC (polycarbonate), PET (polyethylene terephthalate), PBT (polybutylene terephthalate), PA (polyacrylate), POM (polyoxymethylene), UHMWPE (ultrahigh-molecular-weight polyethylene), PP (polypropylene), PE (polyethylene), PPE (polyphenyl ether), and ABS (poly(acrylonitrile butadiene styrene)). Among these plastics, silicon resins, PI, PEEK, PPS, PEI, PPSU, PVDF, PA, PC, PET, PBT, PA, and POM are preferable in terms of an excellent heat resistance.

The shape of the placing unit is not particularly limited and may be appropriately selected depending on the intended purpose so long as the placing unit has translucency. Examples of the shape of the placing unit include a net shape, a plate shape, and a disk shape.

Metallic members formed of, for example, stainless steel, copper, and aluminum can be used as the placing unit so long as they are processed to transmit light therethrough (i.e., processed to have light transmission holes), like, for example, a net, or a plate having many pores in order to transmit light therethrough.

The light transmittance through the placing unit is not particularly limited, may be appropriately selected depending on the intended purpose, and is preferably 20% or higher but 99.9% or lower, more preferably 40% or higher but 99% or lower, yet more preferably 50% or higher but 98% or lower, and particularly preferably 60% or higher but 96% or lower in terms of increasing the efficiency of utilizing light from the light sources and saving costs.

It is preferable that the light transmittance through the placing unit be 20% or higher, because light can be utilized efficiently. It is preferable that the light transmittance through the placing unit be 99.9% or lower, because it is possible to overcome such problems as cost increase due to difficulty with anti-light reflection processing and light transmission hole processing.

When a placing unit processed to have light transmission holes is used in the light cooking device of the present disclosure, the light transmittance through the placing unit is preferably 20% or higher but 100% or lower, more preferably 40% or higher but 99% or lower, yet more preferably 50% or higher but 98% or lower, and particularly preferably 60% or higher but 96% or lower.

In the light cooking device of the present disclosure, it is preferable that the light sources or the placing unit, or both be scannable.

When the light sources are scannable, it is possible to produce a resultant wave using rays of light from the plurality of light sources. This is preferred when more intense heating is necessary.

For example, in the light cooking device 100, all of the LEDs 8 disposed on all of the wall surfaces of the cooking chamber 2 may be scanned, or any of the LEDs 8 that can emit light to the cooking material 6 may be selectively scanned. Of these options, it is preferable to selectively scan any of the LEDs 8 that can emit light to the cooking material 6, in terms of reducing energy loss.

The placing unit that is scannable is preferable because microwave irradiation unevenness is suppressed and the whole of the cooking material can be warmed uniformly. The method for scanning the placing unit can be realized by providing a rotatable structure (for example, a turn table) as the placing unit. When heating and cooking the cooking material using only the light sources without using the heating unit by microwaves in combination, it is preferable not to rotate the placing unit in terms of uniform light irradiation.

### <Light Leakage Preventing Unit>

The material of the light leakage preventing unit is not particularly limited and may be appropriately selected depending on the intended purpose. Examples of the material of the light leakage preventing unit include metals and nonmetals.

Examples of the metals include steel, tool steel, carbon steel, iron-containing alloys, stainless steel, aluminum, nickel, magnesium, titanium, copper, and alloys containing these metals. Among these metals, steel, stainless steel, and aluminum are preferable in terms of an excellent heat resistance and a low light transmittance.

Examples of the nonmetals include ceramics, thermoplastic plastics, thermosetting plastics, heat-resistant plastics, natural rubbers, synthetic rubbers, fiber reinforced plastics, fiber reinforced metals, fiber reinforced ceramics, and metal matrix-combined materials. Among these nonmetals, heat-resistant plastics are preferable in terms of an excellent heat resistance and a low light transmittance.

The size of the light leakage preventing unit is not particularly limited and may be appropriately selected depending on the intended purpose. A size that can fully cover the light sources, the cooking material, the light condensing units, the placing unit, and a protecting plate described below is preferable. A size that can fully cover at least the light sources and the cooking material is more preferable.

The shape of the light leakage preventing unit is not particularly limited and may be appropriately selected depending on the intended purpose. Examples of the shape of the light leakage preventing unit include box shapes and cylindrical shapes.

The structure of the light leakage preventing unit is not particularly limited and may be appropriately selected depending on the intended purpose.

The heatproof temperature of the light leakage preventing unit is not particularly limited and is preferably 50 degrees C. or higher but 1,000 degrees C. or lower, preferably 100 degrees C. or higher but 500 degrees C. or lower, and yet more preferably 140 degrees C. or higher but 300 degrees C. or lower.

When the heatproof temperature of the light leakage preventing unit is 50 degrees C. or higher, problems such as deformation of the light leakage preventing unit during heating and cooking can be overcome. When the heatproof temperature of the light leakage preventing unit is 1,000 degrees C. or lower, problems such as cost increase due to difficulty with processing the light leakage preventing unit can be overcome.

The light transmittance through the light leakage preventing unit is not particularly limited, may be appropriately selected depending on the intended purpose, and is preferably 1% or lower, more preferably 0.1% or lower, and yet more preferably 0.01% or lower in terms of securing safety of the user.

The light leakage preventing unit may include the peep window to enable visually checking the cooking condition of the cooking material.

For example, the peep window 10 may be provided in one surface of the housing 1 and the cooking chamber 2 as illustrated in FIG. 1C, may be provided in a plurality of surfaces thereof, or may be provided in all of the surfaces thereof.

The material of the peep window is not particularly limited and may be appropriately selected depending on the intended purpose so long as the material has translucency and heat resistance. Examples of the material of the peep window include plastics.

Examples of the plastics include silicon resins, PI (polyimide), PEEK (polyether ether ketone), PPS (polyphenylene sulfide), PEI (polyether imide), PPSU (polyphenylene sulfone), PVDF (polyvinylidene fluoride), PA (polyacrylate), PC (polycarbonate), PET (polyethylene terephthalate), PBT (polybutylene terephthalate), PA (polyacrylate), POM (polyoxymethylene), UHMWPE (ultrahigh-molecular-weight polyethylene), PP (polypropylene), PE (polyethylene), PPE (polyphenyl ether), and ABS (poly(acrylonitrile butadiene styrene)). Among these plastics, silicon resins, PI, PEEK, PPS, PEI, PPSU, PVDF, PA, PC, PET, PBT, PA, and POM are preferable in terms of an excellent heat resistance.

The shape, size, and structure of the peep window are not particularly limited and may be appropriately selected depending on the intended purpose.

When the light leakage preventing unit includes the peep window, the light transmittance through the light leakage preventing unit is preferably 0.01% or higher 50% or lower, more preferably 0.1% or higher but 20% or lower, and yet more preferably 1% or higher but 10% or lower.

In order to reduce the light transmittance through the light leakage preventing unit, the transmittance of the whole visible light spectrum through the peep window may be reduced, or a partial wavelength spectrum may be allowed to be transmitted through the peep window. For example, a reflection film that reflects only a partial wavelength spectrum may be provided to transmit only green light having a high visibility and red light that is low-burdening to eyes, and not to transmit blue light.

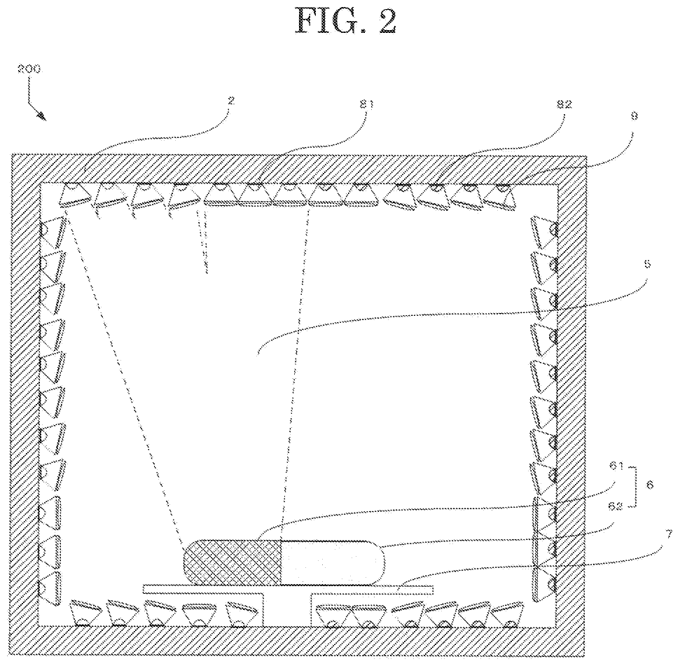

Other embodiments of the light cooking device of the present disclosure will be described with reference to FIG. 2 to FIG. 5. Applications of the cooking device of the present disclosure are not limited to these embodiments.

The same components are denoted by the same reference numerals in the drawings, and any matters these components have in common may not be described redundantly. For example, the number, position, and shape of the components are not limited to these embodiments, and may be any number, position, and shape that are suitable for carrying out the present disclosure.

FIG. 2 is a schematic front cross-sectional view of the light cooking device of the present disclosure in another embodiment. The light cooking device 200 includes a cooking chamber 2 serving as a light leakage preventing unit, a cooking table 7 serving as a placing unit, lit LEDs 81 and extinguished LEDs 82 serving as light sources, and lenses 9 serving as light condensing units. FIG. 2 does not illustrate a housing 1, a waveguide 3, a microwave generator 4, LEDs 8 and lenses 9 disposed on the rear surface of the cooking chamber, light paths other than light paths 5 from the light sources on the top surface, and a peep window 10.

The LEDs 8 can be each driven independently. By lighting some of all the LEDs disposed in the cooking chamber 2, it is possible to heat only an arbitrary part of the cooking material 6. For example, by lighting the LEDs on the left half from the center and extinguishing the LEDs on the right half from the center as illustrated in FIG. 2, it is possible to heat and cook only the left half of the cooking material 6.

For example, the cooking device of the present disclosure can also cope when it is better to heat and sterilize a part of the cooking material or when it is desired to heat only the food desired to warm (for example, meat or fish) on a plate dish on which some kinds of foods such as meat and vegetables are put.

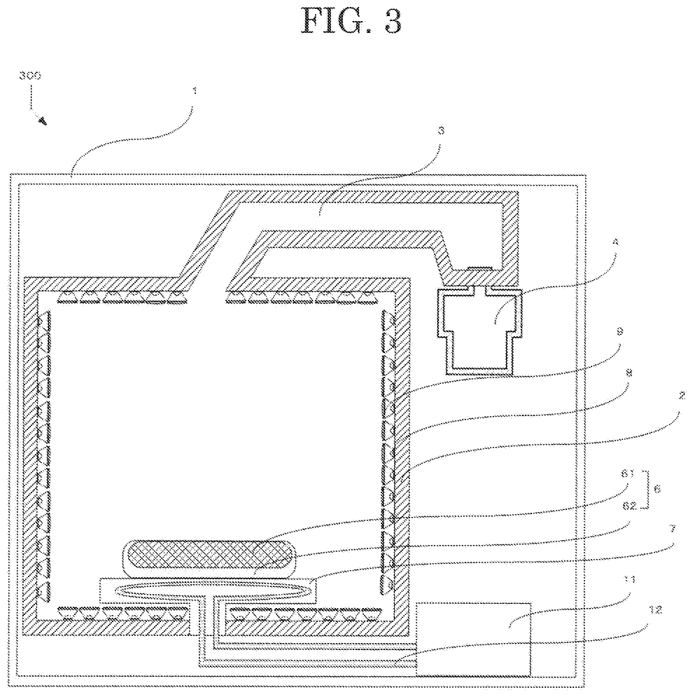

FIG. 3 is a schematic front cross-sectional view of the light cooking device of the present disclosure in another embodiment. The light cooking device 300 includes a housing 1 and a cooking chamber 2 serving as a light leakage preventing unit, a waveguide 3, a microwave generator 4, a cooking table 7 serving as a placing unit, LEDs 8 serving as light sources, lenses 9 serving as light condensing units, a pumping device 11, and a pipe 12. FIG. 3 does not illustrate light paths 5, LEDs 8 and lenses 9 disposed on the rear surface of the cooking chamber, and a peep window 10.

The pipe 12 is coupled to the pumping device 11, and a cooling medium is circulated through the pipe 12 by the pumping function of the pumping device 11. The cooking table 7 is cooled because a part of the pipe 12 is incorporated into the cooking table 7. The cooking table 7 cooled is used as a cooling unit in the light cooking device of the present disclosure.

When it is desired to heat and cook only the inside of the cooking material without heating the surface of the cooking material, or when it is desired to sterilize the cooking material without heating it with a view to a long-term chilled storage of the cooking material, it is suitable to employ the present embodiment that can heat and cook, or sterilize the cooking material without raising the surface temperature of the cooking material.

For example, by heating and cooking the cooking material 6 using the LEDs 8 and the lenses 9 while the cooking material 6 is contacted with the cooking table 7 cooled, it is possible to suppress rising of the surface temperature of the cooking material 6 and heat and cook only the inside of the cooking material 6 without heating the surface of the cooking material 6. Furthermore, by irradiating the cooking material 6 with short-wavelength light while cooling the surface of the cooking material 6, it is possible to sterilize bacteria existing near the surface of the cooking material 6 without heating the cooking material 6.

### <Cooling Unit>

As the cooling unit of the light cooking device of the present disclosure, the cooking table 7 serving as the placing unit may double-function as the cooling unit as illustrated in FIG. 3, or a plurality of cooling units may be provided independently.

When the cooling units are provided independently, the material of the cooling units is not particularly limited and may be appropriately selected depending on the intended purpose so long as the material has translucency. Examples of the material of the cooling units include quartz, glass, and plastics.

Examples of the plastics include polyethylene, polypropylene, vinyl chloride, polystyrene, AS (acrylonitrile styrene) resins, ABS resins, PET, PMMA, vinylidene chloride, polycarbonate, polyamide, polyacetal, PBT, fluororesins, phenol resins, melamine resins, polyurethane, epoxy resins, and polyester. Among these plastics, epoxy resins, phenol resins, fluororesins, polycarbonate, vinylidene chloride, and polypropylene are preferable in terms of an excellent heat resistance, an excellent strength, and easy availability.

When the placing unit double-functions as the cooling unit, the same material as used in the placing unit may be used as the material of the cooling unit.

The shape of the cooling unit is not particularly limited and may be appropriately selected depending on the intended purpose. Examples of the shape of the cooling unit include a plate shape, a disk shape, and a box shape that can contain the cooking material inside.

The cooling unit may have a flexible film shape such as a resin film. When the cooling unit has a flexible film shape, it is possible to closely attach the cooling unit to the cooking material in a manner to conform to the shape of the cooking material and make the cooling unit and the cooking material contact each other by a large area. This is preferable because it is possible to cool the entire surface of the cooking material uniformly even if the cooking material has a complicated shape, and to reduce heating unevenness.

The size of the cooling unit is not particularly limited and may be appropriately selected depending on the intended purpose.

In a preferable structure of the cooling unit, a pipe is included inside the cooling unit. This is preferable because it is possible to cool the cooking material utilizing a heat pipe phenomenon that occurs when a liquid or a gas is fluidized through the pipe.

The liquid fluidized in the cavity is not particularly limited and may be appropriately selected depending on the intended purpose. For example, a cooling medium is preferable.

The cooling medium is not particularly limited and may be appropriately selected depending on the intended purpose. Examples of the cooling medium include water and oils.

When no pipe is included inside the cooling unit, a member having a high thermal conductivity may be provided in addition to the cooling unit, or the cooling unit may be formed of a member having a high thermal conductivity.

The heat dissipation method of the cooling unit is not particularly limited and may be appropriately selected depending on the intended purpose. Examples of the heat dissipation method of the cooling unit include a method of installing a heat sink and cooling the heat sink by, for example, a fan.

In terms of improving the cooling efficiency, it is preferable to provide a Peltier element between the cooling unit and the heat sink.

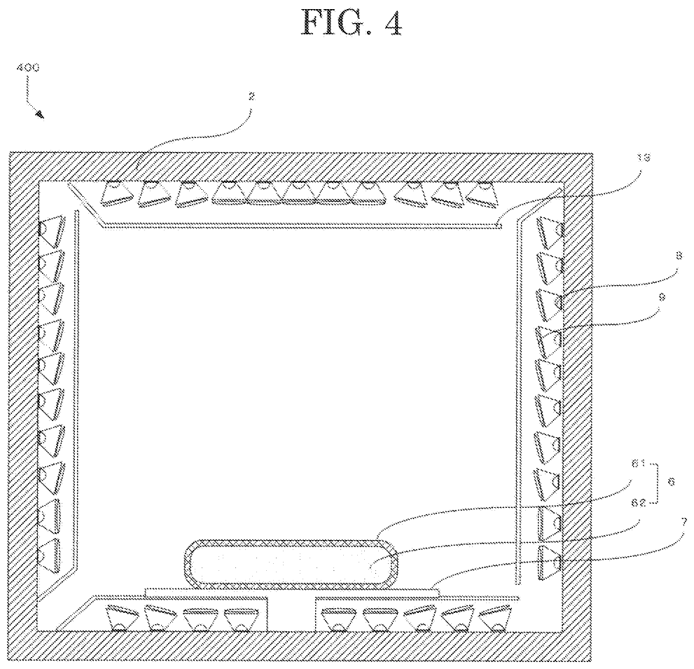

FIG. 4 is a schematic front cross-sectional view of the light cooking device of the present disclosure in another embodiment. The light cooking device 400 includes a cooking chamber 2 serving as a light leakage preventing unit, a cooking table 7 serving as a placing unit, LEDs 8 serving as light sources, lenses 9 serving as light condensing units, and a protecting plate 13 serving as a protecting unit. FIG. 4 does not illustrate a housing 1, a waveguide 3, a microwave generator 4, light paths 5, LEDs 8 and lenses 9 disposed on the rear surface of the cooking chamber, and a peep window 10. The protecting plate 13 is disposed between a cooking material 6 placed on the cooking table 7 and the LEDs 8 and lenses 9.

By providing the protecting plate 13, it is possible to prevent a problem that the cooking material cannot be irradiated with light suitably because, for example, any by-products produced from the cooking material during heating adhere to the LEDs 8.

### <Protecting Unit>

The material of the protecting unit is not particularly limited and may be appropriately selected depending on the intended purpose so long as the material has translucency and heat resistance. Examples of the material of the protecting unit include plastics.

Examples of the plastics include silicon resins, PI (polyimide), PEEK (polyether ether ketone), PPS (polyphenylene sulfide), PEI (polyether imide), PPSU (polyphenylene sulfone), PVDF (polyvinylidene fluoride), PA (polyacrylate), PC (polycarbonate), PET (polyethylene terephthalate), PBT (polybutylene terephthalate), PA (polyacrylate), POM (polyoxymethylene), UHMWPE (ultrahigh-molecular-weight polyethylene), PP (polypropylene), PE (polyethylene), PPE (polyphenyl ether), and ABS (poly(acrylonitrile butadiene styrene)). Among these plastics, silicon resins, PI, PEEK, PPS, PEI, PPSU, PVDF, PA, PC, PET, PBT, PA, and POM are preferable in terms of an excellent heat resistance.

The structure, size, and shape of the protecting unit are not particularly limited and may be appropriately selected depending on the intended purpose.

The position at which the protecting unit is disposed is not particularly limited and may be appropriately selected depending on the intended purpose. It is preferable to dispose the protecting unit at a position at the cooking material side of the light condensing units, because it is possible to also prevent contamination of the light condensing units, not only the light sources.

When the protecting unit is disposed at a position at the cooking material side of the light condensing units, it is preferable to dispose the protecting unit at a position at the light condensing unit side of the middle position between the light condensing units and the cooking material. This is preferable because it is possible to secure a large space in the cooking chamber, and heat and cook the cooking material even if the cooking material has a large size.

When the light cooking device of the present disclosure includes the protecting unit, it is possible to dispose the light sources in a space defined between a wall surface of the cooking chamber and the protecting unit. In this way, it is possible to prevent deterioration of the light sources due to smoke and fume generated from the cooking material during cooking.

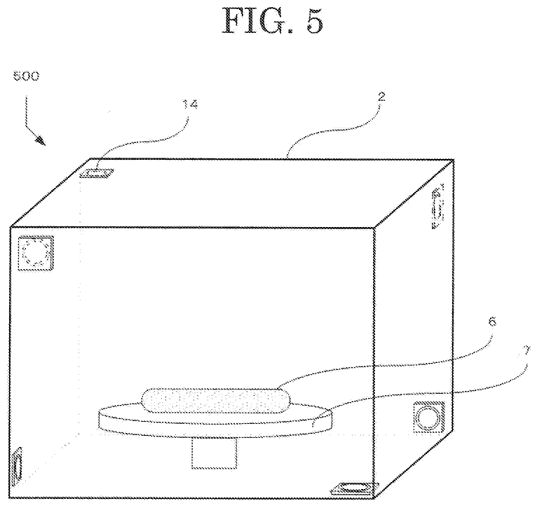

FIG. 5 is a schematic perspective view of the light cooking device of the present disclosure in another embodiment. The light cooking device 500 includes a cooking chamber 2 serving as a light leakage preventing unit, a cooking table 7 serving as a placing unit, and cameras 14 serving as sensing units. FIG. 5 does not illustrate a housing 1, a waveguide 3, a microwave generator 4, LEDs 8, lenses 9, and a peep window 10. A cooking material 6 is placed on the cooking table 7. The cameras 14 are disposed on all wall surfaces in the cooking chamber 2.

In the present embodiment, it is possible to adjust the light volume emitted to the cooking material 6 according to a control method (initial control method) described below.

The size and shape of the cooking material 6 are determined based on the images obtained by capturing the cooking material 6 with the cameras 14 from all directions within 360 degrees, and the positional coordinates of all of the surfaces are obtained as sensing information. The LEDs 8 to be lit are selected, the LEDs 8 are scanned, and the light volume emitted by the LEDs 8 is adjusted using, for example, AI (Artificial Intelligence) in a manner that every set of positional coordinates is irradiated with the equal light volume. In this way, even when the cooking material 6 has a complicated shape, it is possible to heat all of the surfaces of the cooking material 6 uniformly by adjusting the light volume emitted to all of the surfaces of the cooking material 6 to be equal according to the control method described above.

As a feedback control method, it is also possible to adjust the light volume emitted to all of the surfaces of the cooking material 6 based on surface temperature distribution obtained by, for example, thermography measurement, or sensing information such as a brown color after heating and cooking.

Moreover, it is preferable to adjust the output power of the microwaves based on the sensing information, because the whole of the cooking material 6 can be warmed more efficiently.

It is also possible to display the images obtained by capturing the cooking material 6 and sensing information such as temperature distribution on a display such as a touch panel and adjust the doneness at the cooker's discretion. This is preferable because the cooker's request such as cooking fat until it is well-done can be satisfied.

Furthermore, the cooker can select the LEDs 8 to be scanned and set the scanning region at the cooker's discretion based on the sensing information displayed on the display.

### <Sensing Unit>

The sensing unit may include a temperature sensor and a color sensor in addition to the image sensor used in the initial control method.

When the sensing unit of the light cooking device of the present disclosure includes sensors, it is preferable to temporarily extinguish the light sources when obtaining sensing information by image capturing and measurement.

It is possible to vary the current or voltage applied to the light sources to vary the light volume of the light sources. It is also possible to vary the electric power for a certain period by pulse width modulation (PWM). PWM is preferable because PWM can control the electric power digitally and has a low circuit load.

The cycle of PWM is not particularly limited, may be appropriately selected depending on the intended purpose, and is preferably 1 microsecond or longer but 100 minutes or shorter, more preferably 100 microseconds or longer but 20 minutes or shorter, and yet more preferably 10 milliseconds or longer but 5 minutes or shorter. A high-speed circuit is needed for an extremely short PWM cycle, leading to cost increase and durability degradation. A long cooking time is needed at an extremely long PWM cycle.

It is preferable to select a surface material from which an adherent matter can be easily peeled, for the surfaces of the light sources, the light condensing units, the placing unit, the protecting unit, the microwave shielding unit, the cooling unit, the sensing unit, and the light leakage preventing unit of the light cooking device of the present disclosure, or coat the surfaces thereof.

The material of the surface coating is not particularly limited and may be appropriately selected depending on the intended purpose. Examples of the material of the surface coating include fluororesins and silicon resins. When the base material to which the surface coating is applied needs to have translucency, a material having translucency is used also for the material of the surface coating.

It is preferable to design the placing unit and the protecting unit of the light cooking device of the present disclosure detachably. This is preferable in terms of hygiene because the placing unit and the protecting unit can be washed. Moreover, a problem that the cooking material cannot be accurately irradiated with light from the light sources due to, for example, adherent matters can be overcome.

Aspects of the present disclosure are, for example, as follows

<1> A light cooking device, including:

a light source; and

a light condensing unit configured to transmit light from the light source through the light condensing unit and condense the light to at least a part of a cooking material,

wherein the light source is at least one selected from light emitting diodes, organic light emitting diodes, and lasers.

<2> The light cooking device according to <1>, further including:

a placing unit configured for the cooking material to be placed.

<3> The light cooking device according to <1> or <2>, further including:

a light leakage preventing unit configured to prevent the light from leaking from inside the light cooking device to outside the light cooking device.

<4> The light cooking device according to any one of <1> to <3>,

wherein the light source includes a plurality of light sources.

<5> The light cooking device according to <4>,

wherein rays of light from the plurality of light sources have different travelling directions from each other.

<6> The light cooking device according to <4> or <5>,

wherein the plurality of light sources can be driven independently from each other.

<7> The light cooking device according to any one of <4> to <6>,

wherein rays of light from the plurality of light sources have different wavelengths from each other.

<8> The light cooking device according to any one of <4> to <6>,

wherein the plurality of light sources or the placing unit, or both are scannable.

<9> The light cooking device according to any one of <1> to <8>,

wherein a wavelength of the light source has a peak at 1,000 nm or less.

<10> The light cooking device according to any one of <1> to <9>,

wherein the light source is a light emitting diode.

<11> The light cooking device according to any one of <1> to <10>, further including:

a protecting unit disposed between the light source and the cooking material, the protecting unit being configured to prevent deterioration of the light source.

<12> The light cooking device according to any one of <1> to <11>, further including:

a cooling unit configured to cool the cooking material.

<13> The light cooking device according to any one of <1> to <12>,

wherein the light cooking device performs at least one selected from selection of the light source to be lit, adjustment of a light volume, and adjustment of an output power of microwaves based on sensing information about the cooking material.

<14> A light cooking method, including:

cooking a cooking material using the light cooking device according to any one of <1> to <13>.

The light cooking device according to any one of <1> to <13> and the light cooking method according to <14> can overcome the various problems in the related art and achieve the object of the present disclosure.

What is claimed is:

1. Alight cooking device, comprising:
a light source; and
a light condensing unit configured to transmit light from the light source through the light condensing unit and condense the light to at least a part of a cooking material,
wherein the light source is at least one selected from light emitting diodes, organic light emitting diodes, and lasers.

2. The light cooking device according to claim 1, further comprising:
a placing unit configured for the cooking material to be placed.

3. The light cooking device according to claim 1, further comprising:
a light leakage preventing unit configured to prevent the light from leaking from inside the light cooking device to outside the light cooking device.

4. The light cooking device according to claim 1,
is wherein the light source includes a plurality of light sources.

5. The light cooking device according to claim 4,
wherein rays of light from the plurality of light sources have different travelling directions from each other.

6. The light cooking device according to claim 4,
wherein the plurality of light sources can be driven independently from each other.

7. The light cooking device according to claim 4,
wherein rays of light from the plurality of light sources have different wavelengths from each other.

8. The light cooking device according to claim 4,
wherein the plurality of light sources or the placing unit, or both are scannable.

9. The light cooking device according to claim 1,
wherein a wavelength of the light source has a peak at 1,000 nm or less.

10. The light cooking device according to claim 1,
wherein the light source is a light emitting diode

11. The light cooking device according to claim 1, further comprising:
a protecting unit disposed between the light source and the cooking material, the protecting unit being configured to prevent deterioration of the light source.

12. The light cooking device according to claim 1, further comprising:
a cooling unit configured to cool the cooking material.

13. The light cooking device according to claim 1,
wherein the light cooking device performs at least one selected from selection of the light source to be lit, adjustment of a light volume, and adjustment of an output power of microwaves based on sensing information about the cooking material.

14. A light cooking method, comprising:
cooking a cooking material using the light cooking device according to claim 1.
